(19) United States
(12) Patent Application Publication
(10) Pub. No.: US 2026/0187523 A1
(43) Pub. Date: Jul. 2, 2026

(54) PERFORMING ON-DEVICE REINFORCEMENT LEARNING (RL) FOR OPTIMIZATION IN PROCESSOR-BASED DEVICES

(71) Applicant: QUALCOMM Incorporated, San Diego, CA (US)

(72) Inventors: Rissen Alfonso Joseph, San Diego, CA (US); Fernando Mendoza Rincon, San Diego, CA (US); Gautham Nagaraju, Poway, CA (US); Christopher Ahn, San Diego, CA (US); Nishith Chaubey, San Diego, CA (US); Blake Royse Johnson, San Diego, CA (US)

(21) Appl. No.: 19/004,688

(22) Filed: Dec. 30, 2024

(51) Int. Cl. G06N 20/00

(52) U.S. Cl. CPC G06N 20/00

(57) ABSTRACT

Performing on-device reinforcement learning (RL) for optimization in processor-based devices is disclosed herein. In some aspects, a processor-based device comprises an optimization circuit that is configured to receive a first reward vector, comprising a plurality of reward values, and a state for a current time interval. The optimization circuit is further configured to generate, using an RL model, one or more actions for a next time interval based on maximizing a scalarized value of expected discounted cumulative rewards for future time intervals. The optimization circuit determines whether a predicted system configuration corresponding to the one or more actions is different from a current system configuration. If so, the optimization circuit performs the one or more actions to apply the predicted system configuration.

### TECHNICAL FIELD

The technology of the disclosure relates generally to system resource management in processor-based devices, and, in particular, to proactively optimizing power, performance, and thermal parameters of processor-based devices.

### BACKGROUND

One aspect of conventional processor-based devices that is essential to optimizing performance is the management of system resources and resource states (including power, clock frequency, and thermal states) and the handling of task concurrencies and other performance considerations such as system latencies, technical protocols, and the like. This functionality is important for performance optimization because failure to efficiently handle system resources and task concurrencies can result in inefficient system usage that, in turn, causes internal system deadlines, both “hard” (i.e., a deadline critical to proper system functionality) and “soft” (i.e., a deadline important for meeting desired key performance indicators (KPI)) to be missed. Missing a “hard” deadline may result in a system crash of the processor-based device due to failure to meet real-time operating requirements, while missing a “soft” deadline may cause systems tasks to not be performed within a desired time interval, causing KPIs to suffer.

Current system management approaches use different techniques in managing power, performance, and thermal states of processor-based devices. One such approach is Clock Power Management (CPM), which involves generating both static and dynamic characterizations of different system operating conditions and corresponding system configuration settings to be applied for those operating conditions. CPM's static characterization involves generating characterizations of steady state operating conditions, and applying a corresponding processor configuration when the processor-based device enters the steady state operating conditions. In addition, reactive characterization under CPM involves attempting to identify a root cause of a processor crash, and, if no root cause can be identified, identifying the operating condition and adding mapping to a CPM lookup table (LUT) for the identified operating condition and the processor configuration. Another such system management approach is Dynamic Voltage Frequency Scaling (DVFS), which enables a processor-based device to dynamically adjust the voltage and clock frequency of the processor-based device based on its current workload.

However, these approaches suffer from disadvantages. In particular, they may face challenges in managing system resources in an optimal manner due to the sheer number of tunable parameters and settings for managing power, performance, and thermal states of the processor-based device. For example, it may be virtually impossible to characterize all possible combinations of tunable parameters in a way that allows them to be programmatically set in response to system operating conditions. It may also be impractical to allocate a large enough data structure to store such characterizations, especially in memory-constrained processor-based devices. Moreover, the overwhelming number of tunable parameters and settings may make it impossible to identify a root cause of a crash, which causes the processor-based device to cope with the crash by increasing system resources and consequently consuming more power. Such crashes may also degrade regular system operations, negatively affect user experience, and divert programmer resources away from implementing new features.

Thus, it is desirable to provide a mechanism for system optimization that can proactively reduce crashes, improve mean time between failures (MTBF), reduce out-of-service times, and improve power consumption.

### SUMMARY OF THE DISCLOSURE

Aspects disclosed in the detailed description include performing on-device reinforcement learning (RL) for optimization in processor-based devices. Related apparatus, methods, and computer-readable media are also disclosed. In this regard, in some exemplary aspects disclosed herein, a processor-based device (such as a modem device, as a non-limiting example) comprises an optimization circuit that is configured to employ an RL model to efficiently optimize system resources while balancing power, performance, and thermal states of the processor-based device. As used herein, an “RL model” refers to a machine-learning model in which an agent (the optimization circuit, in aspects disclosed herein) interacts with an environment (i.e., the processor-based device) and, given a current state of the processor-based device, determines one or more actions to perform (i.e., to update a system configuration of the processor-based device) to maximize a reward.

In exemplary operation, the optimization circuit receives a first reward vector, comprising a plurality of reward values, and a state for a current time interval. The reward values according to some aspects may include a power reward value based on a digital power meter (DPM) value, a performance reward value calculated based on a sum of differences between a series of current timeline margin values and corresponding target timeline margin values, and a thermal reward value calculated based on a sum of differences between a series of target thermal state values and corresponding current thermal state values of the processor-based device. A “DPM,” as used herein, refers to a device configured to use hardware performance counters (HPCs) or other use case metadata to predict power or energy consumed by the processor-based device during a specified time interval. The target timeline margins and the target thermal state values according to some aspects may be based on a current operating condition of the processor-based device, and thus may be modified based on different use cases for the processor-based device. The state provided to the optimization circuit may comprise an HPC history of the processor device, a configuration of the processor-based device, an action sequence history of the processor-based device, and/or an application metadata history of the processor-based device.

The optimization circuit next generates, using an RL model, one or more actions for a next time interval based on maximizing a scalarized value of expected discounted cumulative rewards for future time intervals. In some aspects, the optimization circuit is configured to maximize the scalarized value of expected discounted cumulative rewards (also known as scalarized expected return (SER)) at any time step. Scalarization may performed by computing a dot product with weights that signify the relative importance of power, performance, and thermal aspects after the respective expectation for different rewards are computed (expected cumulative discounted reward vector). The one or more actions may comprise one or more of a resource management operation, a capability throttling operation, a software mitigation operation, and/or a clock operation that may be performed by the optimization circuit to modify the system configuration of the processor-based device. The optimization circuit then determines whether a predicted system configuration corresponding to the one or more actions (i.e., the system configuration that would result from performing the one or more actions) is different from a current system configuration. If so, the optimization circuit performs the one or more actions to apply the predicted system configuration. In some aspects, the optimization circuit then waits for the end of the current time interval, and repeats the operations during the next time interval. In this manner, aspects disclosed herein can take a proactive and forward-looking approach to optimization by predicting a system configuration best suited to the state of the processor-based device, without the need to identify and characterize all possible combinations of system states.

In some aspects, the RL model of the optimization circuit may be initialized based on a thermal/performance/power (TPP) reward model and a state transition model. The TPP reward model in such aspects may comprise a model representing a next thermal, performance, and/or power reward given an action taken from an existing state, while the state transition model may comprise data representing different states of HPCs, and the conditions or triggers in response to which each corresponding HPC may transition from one state to another.

In another aspect, a processor-based device is provided. The processor-based device comprises an optimization circuit that is configured to receive a first reward vector, comprising a plurality of reward values, and a state for a current time interval. The optimization circuit is further configured to generate, using an RL model, one or more actions for a next time interval based on maximizing a scalarized value of expected discounted cumulative rewards for future time intervals. The optimization circuit is also configured to determine whether a predicted system configuration corresponding to the one or more actions is different from a current system configuration. The optimization circuit is additionally configured to, responsive to determining that the predicted system configuration corresponding to the one or more actions is different from the current system configuration, perform the one or more actions to apply the predicted system configuration.

In another aspect, a processor-based device is provided. The processor-based device comprises means for receiving a first reward vector, comprising a plurality of reward values, and a state for a current time interval. The processor-based device further comprises means for generating, using an RL model, one or more actions for a next time interval based on maximizing a scalarized value of expected discounted cumulative rewards for future time intervals. The processor-based device also comprises means for determining whether a predicted system configuration corresponding to the one or more actions is different from a current system configuration. The processor-based device additionally comprises means for performing the one or more actions to apply the predicted system configuration, responsive to determining that the predicted system configuration corresponding to the one or more actions is different from the current system configuration.

In another aspect, a method for performing on-device RL for optimization in processor-based devices is disclosed. The method comprises receiving, by an optimization circuit of a processor-based device, a first reward vector, comprising a plurality of reward values, and a state for a current time interval. The method further comprises generating, by the optimization circuit using an RL model, one or more actions for a next time interval based on maximizing a scalarized value of expected discounted cumulative rewards for future time intervals. The method also comprises determining, by the optimization circuit, that a predicted system configuration corresponding to the one or more actions is different from a current system configuration. The method additionally comprises, responsive to determining that the predicted system configuration corresponding to the one or more actions is different from the current system configuration, performing, by the optimization circuit, the one or more actions to apply the predicted system configuration.

In another aspect, a non-transitory computer-readable medium is disclosed. The non-transitory computer-readable medium stores computer-executable instructions that, when executed, cause a processor device of a processor-based device to receive a first reward vector, comprising a plurality of reward values, and a state for a current time interval. The computer-executable instructions further cause the processor device to generate, using an RL model, one or more actions for a next time interval based on maximizing a scalarized value of expected discounted cumulative rewards for future time intervals. The computer-executable instructions also cause the processor device to determine whether a predicted system configuration corresponding to the one or more actions is different from a current system configuration. The computer-executable instructions additionally cause the processor device to, responsive to determining that the predicted system configuration corresponding to the one or more actions is different from the current system configuration, perform the one or more actions to apply the predicted system configuration.

### BRIEF DESCRIPTION OF THE FIGURES

FIG. 1 is a diagram of an exemplary processor-based system that includes a processor-based device with an optimization circuit comprising reservation stations configured to perform on-device reinforcement learning (RL) for optimization, according to some aspects;

FIG. 2 is a flowchart illustrating exemplary operations performed by the processor device of FIG. 1 for performing on-device RL for optimization, according to some aspects; and

FIG. 3 is a block diagram of an exemplary processor-based device that can include the processor device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise expressly indicated.

Aspects disclosed in the detailed description include performing on-device reinforcement learning (RL) for optimization in processor-based devices. Related apparatus, methods, and computer-readable media are also disclosed. In this regard, in some exemplary aspects disclosed herein, a processor-based device (such as a modem device, as a non-limiting example) comprises an optimization circuit that is configured to employ an RL model to efficiently optimize system resources while balancing power, performance, and thermal states of the processor-based device. As used herein, an “RL model” refers to a machine-learning model in which an agent (the optimization circuit, in aspects disclosed herein) interacts with an environment (i.e., the processor-based device) and, given a current state of the processor-based device, determines one or more actions to perform (i.e., to update a system configuration of the processor-based device) to maximize a reward.

In exemplary operation, the optimization circuit receives a first reward vector, comprising a plurality of reward values, and a state for a current time interval. The reward values according to some aspects may include a power reward value based on a digital power meter (DPM) value, a performance reward value calculated based on a sum of differences between a series of current timeline margin values and corresponding target timeline margin values, and a thermal reward value calculated based on a sum of differences between a series of target thermal state values and corresponding current thermal state values of the processor-based device. A “DPM,” as used herein, refers to a device configured to use hardware performance counters (HPCs) or other use case metadata to predict power or energy consumed by the processor-based device during a specified time interval. The target timeline margins and the target thermal state values according to some aspects may be based on a current operating condition of the processor-based device, and thus may be modified based on different use cases for the processor-based device. The state provided to the optimization circuit may comprise an HPC history of the processor device, a configuration of the processor-based device, an action sequence history of the processor-based device, and/or an application metadata history of the processor-based device.

The optimization circuit next generates, using an RL model, one or more actions for a next time interval based on maximizing a scalarized value of expected discounted cumulative rewards for future time intervals. In some aspects, the optimization circuit is configured to maximize the scalarized value of expected discounted cumulative rewards (also known as scalarized expected return (SER)) at any time step. Scalarization may performed by computing a dot product with weights that signify the relative importance of power, performance, and thermal aspects after the respective expectation for different rewards are computed (expected cumulative discounted reward vector). The one or more actions may comprise one or more of a resource management operation, a capability throttling operation, a software mitigation operation, and/or a clock operation that may be performed by the optimization circuit to modify the system configuration of the processor-based device. The optimization circuit then determines whether a predicted system configuration corresponding to the one or more actions (i.e., the system configuration that would result from performing the one or more actions) is different from a current system configuration. If so, the optimization circuit performs the one or more actions to apply the predicted system configuration. In some aspects, the optimization circuit then waits for the end of the current time interval, and repeats the operations during the next time interval. In this manner, aspects disclosed herein can take a proactive and forward-looking approach to optimization by predicting a system configuration best suited to the state of the processor-based device, without the need to identify and characterize all possible combinations of system states.

In some aspects, the RL model of the optimization circuit may be initialized based on a thermal/performance/power (TPP) reward model and a state transition model. The TPP reward model in such aspects may comprise a model representing a next thermal, performance, and/or power reward given an action taken from an existing state, while the state transition model may comprise data representing different states of HPCs, and the conditions or triggers in response to which each corresponding HPC may transition from one state to another.

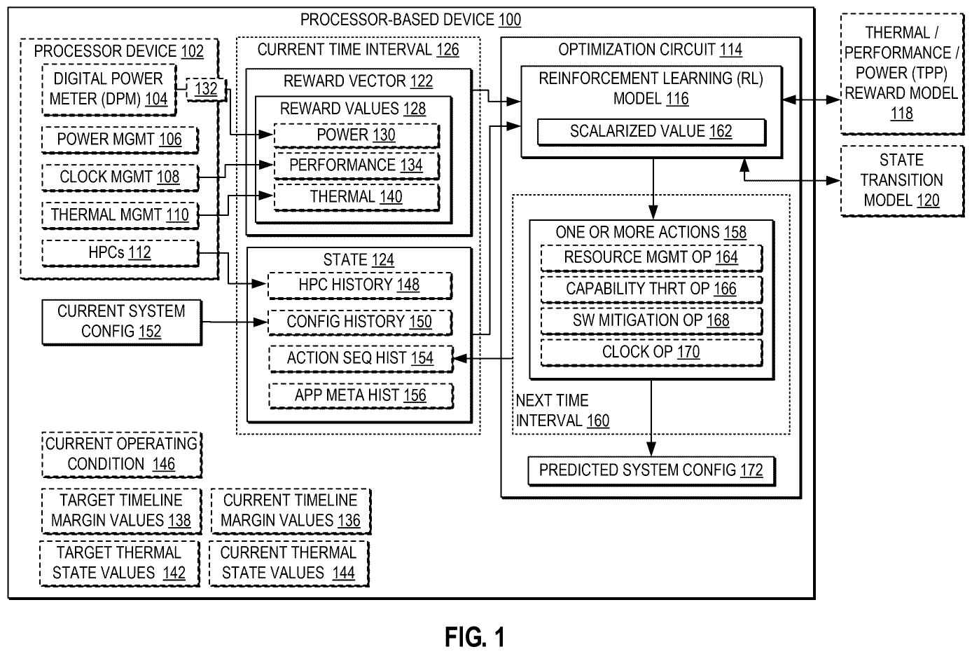

In this regard, FIG. 1 is a diagram of an exemplary processor-based device 100. The processor-based device 100 may comprise a modem device, as a non-limiting example, and may include a processor device 102. In the example of FIG. 1, the processor device 102 provides functionality for managing system resources and states of the processor-based device 100. In this regard, the processor device 102 provides a DPM circuit (captioned as “DIGITAL POWER METER (DPM)” in FIG. 1) 104 that is configured to use HPCs or other use case metadata to predict power or energy consumed by the processor-based device 100 during a specified time interval. The processor device 102 further provides a power management circuit (captioned as “POWER MGMT” in FIG. 1) 106 that is configured to control power states of the processor-based device 100 by, e.g., placing the processor device 102 in lower- or higher-power modes depending on a use case of the processor-based device 100.

The processor device 102 also provides a clock management circuit (captioned as “CLOCK MGMT” in FIG. 1) 108 that is configured to control a clock frequency of the processor device 102. For example, the clock management circuit 108 may be configured to increase the clock frequency of the processor device 102 in response to the processor device 102 experiencing a heavy workload, and may be configured to decrease the clock frequency of the processor device 102 in response to the processor device 102 experiencing a lower workload.

The processor device 102 in the example of FIG. 1 additionally provides a thermal management circuit (captioned as “THERMAL MGMT” in FIG. 1) 110 that is configured to monitor a thermal state of the processor-based device 100. Data provided by the thermal management circuit 110 may be used by the processor device 102 when performing power and/or clock frequency modifications using the power management circuit 106 and the clock management circuit 108, respectively. For example, if the thermal management circuit 110 indicates that the processor-based device 100 is in danger of exceeding a maximum thermal threshold, the processor device 102 may decrease the clock frequency and/or the power level at which some or all elements of the processor-based device 100 operates. Finally, the processor device 102 of FIG. 1 includes a plurality of HPCs 112. Each of the HPCs 112 comprises a counter that is configured to automatically track a number of occurrences of a corresponding event or process during operation of the processor device 102.

The processor-based device 100 of FIG. 1 and the constituent elements thereof may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include elements in addition to those illustrated in FIG. 1. For example, the processor device 102 may further include one or more instruction caches, unified caches, controller circuits, interconnect buses, and/or additional memory devices, caches, and/or controller circuits that are not shown in FIG. 1 for the sake of clarity. It is to be further understood that, while illustrated as separate elements in FIG. 1 for the sake of clarity, elements such as the DPM 104, the clock management circuit 108 and/or the thermal management circuit 110 may be implemented as a single element performing the functionality of each constituent element shown in FIG. 1.

As noted above, conventional approaches to system management tend to be reactive rather than proactive, and face further challenges in managing system resources in an optimal manner due to the sheer number of tunable parameters and settings for managing power, performance, and thermal states of the processor-based device 100. For example, it may be virtually impossible to characterize all possible combinations of tunable parameters in a way that allows them to be programmatically set in response to system operating conditions, or to identify a root cause of a crash.

In this regard, the processor-based device 100 provides an optimization circuit 114 configured to perform on-device RL for optimization. The optimization circuit 114 may be implemented as a custom accelerator circuit of the processor-based device 100, or may be implemented using an existing accelerator circuit of the processor-based device 100. While shown as an element separate from the processor device 102, it is to be understood that the optimization circuit 114 according to some aspects may be implemented as an integral element of the processor device 102.

In exemplary operation, the optimization circuit 114 provides an RL model (captioned as “REINFORCEMENT LEARNING (RL) MODEL” in FIG. 1) 116. As is known in the art, RL models such as the RL model 116 use a machine learning paradigm under which an agent (the optimization circuit 114, in aspects disclosed herein) learns to make decisions by interacting with an environment (the processor-based device 100, in aspects disclosed herein). The RL model 116 is configured to receive information about a state of the processor-based device 100 and rewards from previous iterations, and attempts to maximize cumulative future reward over time. The RL model 116 according to some aspects may be employ a Markov decision process (MDP).

In some aspects, the RL model 116 may be initialized based on a TPP reward model (captioned as “THERMAL/PERFORMANCE/POWER (TPP) REWARD MODEL” in FIG. 1) 118 and a state transition model 120. The TPP reward model 118 in such aspects may comprise a model representing a next thermal, performance, and/or power reward given an action taken from an existing state, while the state transition model 120 may comprise data representing different states of one or more of the HPCs 112 and the conditions or triggers in response to which each corresponding HPC 112 may transition from one state to another, as well as any other metadata required to characterize the workload of the processor-based device 100. The TPP reward model 118 and the state transition model 120 may subsequently receive feedback from the RL model 116 to enable them to change on target and continue to learn and move towards an optimal model.

The optimization circuit 114 receives a first reward vector (captioned as “REWARD VECTOR” in FIG. 1) 122 and a state 124 for a current time interval 126 during which the processor-based device 100 is operational. The first reward vector 122 comprises a plurality of reward values 128, each of which represents a value that corresponds to a characteristic of the processor-based device 100. According to some aspects, the reward values 128 may include a power reward value (captioned as “POWER” in FIG. 1) 130 that is based on a DPM value 132 received from the DPM 104. In some aspects, the power reward value 130 may comprise a negative of the DPM value 132 because it is desirable to minimize power consumption of the processor-based device 100, but the RL model 116 will seek to identify actions that will result in maximum possible reward values. The reward values 128 may further comprise a performance reward value (captioned as “PERFORMANCE” in FIG. 1) 134 that is calculated based on a sum of differences between a series of current timeline margin values 136 and corresponding target timeline margin values 138, and, as seen below in Table 1, may also incorporate corresponding weight values. As used herein, a “timeline” refers to a maximum time interval during which a specified operation or process is expected to complete, and a “timeline margin value” refers to the difference between the maximum time interval and the actual time taken for the operation or process to complete. The reward values 128 may also comprise a thermal reward value (captioned as “THERMAL” in FIG. 1) 140 that is calculated based on a sum of differences between a series of target thermal state values 142 and corresponding current thermal state values 144 of the processor-based device 100, and, in some aspects, may incorporate corresponding weight values.

The reward values 128 in such aspects are illustrated in Table 1 below:

TABLE 1
R_{dpm} represents the power reward value 130, calculated as, e.g., a negative of the
DPM value 132.
R_{perf} represents the performance reward value 134, calculated as follows:

| | |
|---|---|
| | R_{perf} = wₚ₁ * xₚ₁ + wₚ₂ * xₚ₂ + wₚ₃ * xₚ₃ + .... + wₚₙ* xₚₙ |
| • | Where xₚₙ is the margin of the nth performance timeline |
| • | target_margin is a corresponding one of the target timeline margin values 138 |

| | |
|---|---|
| • | Such that: |

| | |
|---|---|
| • | xₚₙ = min(0, curr_margin − target_margin) |
| • | w₁ + w₂ + w₃ + .... + wₙ = 1; weights are picked based on expert |
| | domain knowledge |

| | |
|---|---|
| • | Note that, with regards to the performance reward value 134, the number of |
| | margins involved in the calculation can increase to the point of being |
| | unmanageable. Accordingly, in that scenario, a machine learning (ML) |
| | model could be implemented to learn an abstraction (e.g., a number [0,−1]) |
| | of all margins for a given state. This abstraction would replace R_{perf}. |

Rₜₕₑᵣₘ represents the thermal reward value 140 (based on delta from target thermal
state values 142), calculated as follows:

| | |
|---|---|
| | Rₜₕₑᵣₘ = wₜ₁ * xₜ₁ + wₜ₂ * xₜ₂ + wₜ₃ * xₜ₃ + .... + wₜₙ* xₜₙ |
| • | Where xₜₙ is delta of a current thermal reading and a corresponding one of the |
| | target thermal state values 142 from sensor n. |

| | |
|---|---|
| • | Such that: |

| | |
|---|---|
| • | xₜₙ = min(0, target_thermal_state − current_thermal_state) |
| • | wₜ₁ + wₜ₂ + wₜ₃ + .. + wₜₙ = 1 ; weights are picked given expert |
| | domain knowledge |

Total Reward corresponds to each of the reward values 128, calculated as follows:

Total Reward = w_{dpm} * R_{dpm} + w_{perf} * R_{perf} + wₜₕₑᵣₘ * Rₜₕₑᵣₘ

| | |
|---|---|
| • | Such that: |

| | |
|---|---|
| • | w_{dpm} + w_{perf} + wₜₕₑᵣₘ = 1 |

Some aspects may provide that the target timeline margin values 138 and the target thermal state values 142 (from which the performance reward value 134 and the thermal reward value 140, respectively, are derived) may be based on a current operating condition 146. Thus, for example, the current operating condition 146 may comprise a current use case under which the processor-based device 100 is operating, and/or a current environmental temperature in which the processor-based device 100 is operating. In some aspects, the state 124 may comprise one or more of an HPC history 148 that represents a record of previous values of one or more of the HPCs 112. The state 124 according to some aspects may comprise a configuration history (captioned as “CONFIG HIST” in FIG. 1) 150 of the processor-based device 102, including a current system configuration (captioned as “CURRENT SYSTEM CONFIG” in FIG. 1) 152. The current system configuration 152 may comprise one or more current values of a corresponding one or more tunable parameters (e.g., parameters or settings of the power management circuit 106, the clock management circuit 108, and/or the thermal management circuit 110, as non-limiting examples) of the processor-based device 100. Some aspects may provide that the state 124 comprises an action sequence history (captioned as “ACTION SEQ HIST” in FIG. 1) 154 tracking previous actions generated by the RL model 116, and/or may comprise an application metadata history (captioned as “APP META HIST” in FIG. 1) 156 that tracks a history of application-specific metadata such as application configuration data.

The optimization circuit 114 next uses the RL model 116 to generate one or more actions 158 for a next time interval 160. The RL model 116 generates the one or more actions 158 by identifying actions that will maximize a scalarized value (captioned as “SCALARIZED VALUE” in FIG. 1) 162 of expected discounted cumulative rewards for future time intervals following the current time interval 126. The discount factor employed may be configurable to enable tuning such that the cumulative future rewards represent a more immediate shorter-term aspect, or a longer-term aspect. The one or more actions 158 in some aspects may comprise one or more of a resource management operation (captioned as “RESOURCE MGMT OP” in FIG. 1) 164, a capability throttling operation (captioned as “CAPABILITY THRT OP” in FIG. 1) 166, a software mitigation operation (captioned as “SW MITIGATION OP” in FIG. 1) 168, and a clock operation (captioned as “CLOCK OP” in FIG. 1) 170, each of which may be directed to corresponding ones of the power management circuit 106, the clock management circuit 108, the thermal management circuit 110, and/or other elements of the processor-based device 100 as necessary.

The optimization circuit 114 then determines whether a predicted system configuration 172 corresponding to the one or more actions 158 is different from the current system configuration 152. This may be accomplished by the optimization circuit 114 generating the predicted system configuration 172 as a system configuration that would result if the one or more actions 158 is performed. If the predicted system configuration 172 is different from the current system configuration 152, the optimization circuit 114 performs the one or more actions 158 to apply the predicted system configuration 172. This may involve, e.g., the optimization circuit 114 transmitting commands to the power management circuit 106, the clock management circuit 108, the thermal management circuit 110, and/or other elements of the processor-based device 100 as necessary. In some aspects, the optimization circuit 114 then waits for the end of the current time interval 126, and then repeats the operation using an updated reward vector based on the scalarized value 162 during the next time interval 160.

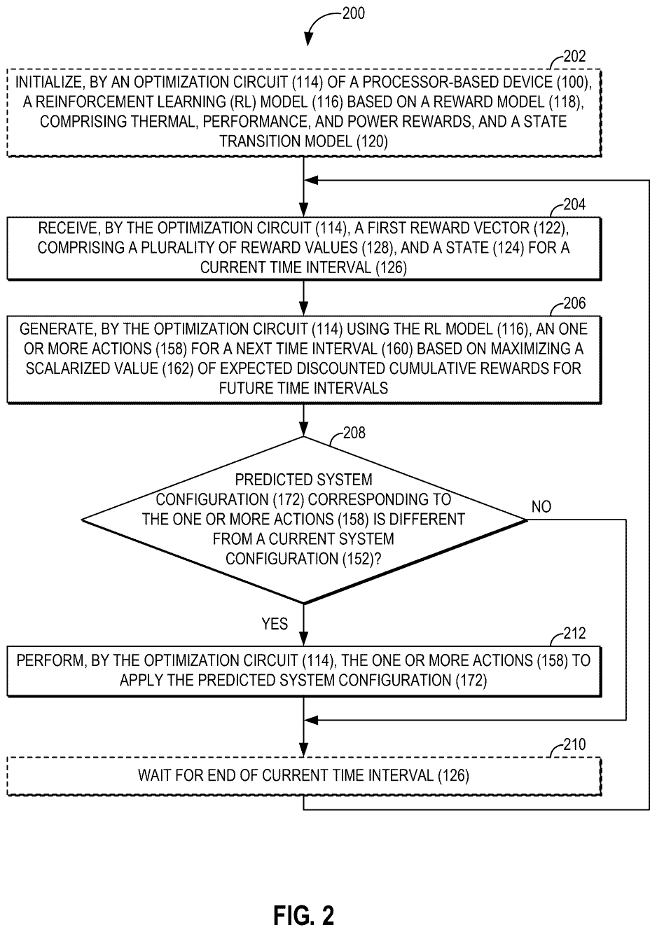

To illustrate operations performed by the processor-based device 100 of FIG. 1 for performing on-device RL for optimization according to some aspects, FIG. 2 provides a flowchart showing exemplary operations 200. For the sake of clarity, elements of FIG. 1 are referenced in describing FIG. 2. It is to be understood that some aspects may provide that some operations illustrated in FIG. 2 may be performed in an order other than that illustrated herein, and/or may be omitted.

The exemplary operations 200 begin in some aspects with an optimization circuit (such as the optimization circuit 114 of FIG. 1) of a processor-based device (e.g., the processor-based device 100 of FIG. 1) initializing an RL model (such as the RL model 116 of FIG. 1) based on a TPP reward model (e.g., the TPP reward model 118 of FIG. 1) and a state transition model (such as the state transition model 120 of FIG. 1) (block 202). The optimization circuit 114 subsequently receives a first reward vector (e.g., the reward vector 122 of FIG. 1), comprising a plurality of reward values (such as the reward values 128 of FIG. 1), and a state (e.g., the state 124 of FIG. 1) for a current time interval (such as the current time interval 126 of FIG. 1) (block 204).

As discussed above with respect to FIG. 1, the reward values 128 according to some aspects may include a power reward value (e.g., the power reward value 130 of FIG. 1) based on a DPM value (such as the DPM value 132 provided by the DPM 104 of FIG. 1), a performance reward value (e.g., the performance reward value 134 of FIG. 1) calculated based on a sum of differences between a series of current timeline margin values (such as the current timeline margin values 136 of FIG. 1) and corresponding target timeline margin values (e.g., the target timeline margin values 138 of FIG. 1), and a thermal reward value (such as the thermal reward value 140) calculated based on a sum of differences between a series of target thermal state values (such as the target thermal state values 142 of FIG. 1) and corresponding current thermal state values (e.g., the current thermal state values 144 of FIG. 1). The target timeline margin values 138 and the target thermal state values 142 according to some aspects may be based on a current operating condition (such as the current operating condition 146 of FIG. 1). Some aspects may provide that the state 124 comprises an HPC history (e.g., the HPC history 148 of FIG. 1) and a configuration of the processor-based device (such as the current system configuration 152 of FIG. 1).

The optimization circuit 114 next generates, using the RL model 116, one or more actions (e.g., the one or more actions 158 of FIG. 1) for a next time interval (such as the next time interval 160 of FIG. 1) based on maximizing a scalarized value (e.g., the scalarized value 162 of FIG. 1) of expected discounted cumulative rewards for future time intervals (block 206). As noted above with respect to FIG. 1, the one or more actions 158 may comprise one or more of a resource management operation (such as the resource management operation 164 of FIG. 1), a capability throttling operation (e.g., the capability throttling operation 166 of FIG. 1), a software mitigation operation (such as the software mitigation operation 168 of FIG. 1), and a clock operation (e.g., the clock operation 170 of FIG. 1).

The optimization circuit 114 then determines whether a predicted system configuration (such as the predicted system configuration 172 of FIG. 1) corresponding to the one or more actions 158 is different from a current system configuration (e.g., the current system configuration 152 of FIG. 1) (block 208). If not, processing continues at block 210 of FIG. 2. However, if the optimization circuit 114 determines at decision block 208 that the predicted system configuration 172 corresponding to the one or more actions 158 does differ from the current system configuration 152, the optimization circuit 114 performs the one or more actions 158 to apply the predicted system configuration 172 (block 212). In some aspects, the optimization circuit 114 then waits for the end of the current time interval 126 (block 210). At that point, processing resumes at block 204, and the exemplary operations 200 may be repeated.

The processor device according to aspects disclosed herein and discussed with reference to FIGS. 1-2 may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

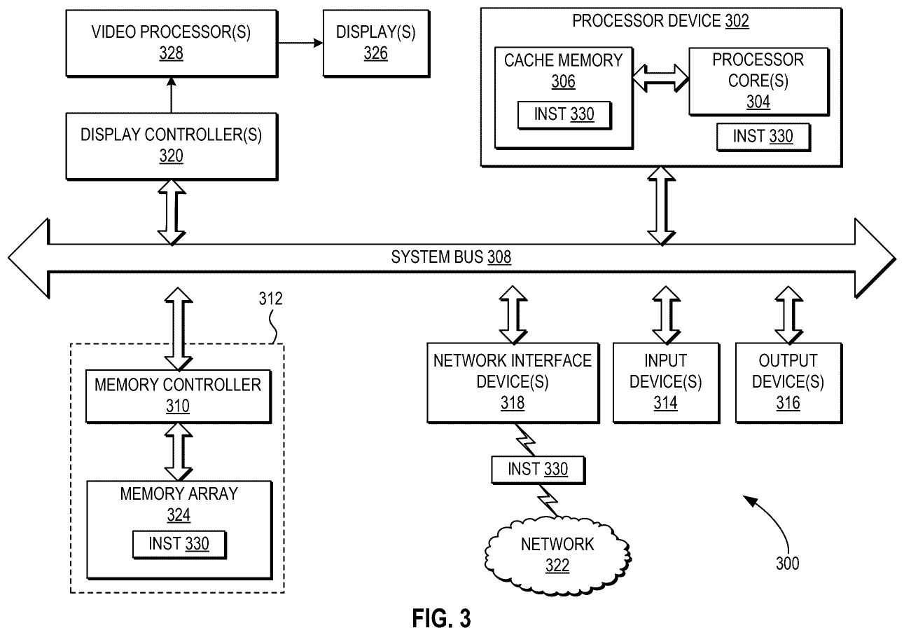

In this regard, FIG. 3 illustrates an example of a processor-based device 300, which corresponds in functionality to the processor-based device 100 of FIG. 1. In this example, the processor-based device 300 includes a processor device 302 (corresponding to the processor device 102 of FIG. 1) that comprises one or more processor cores 304 coupled to a cache memory 306. The processor device 302 is also coupled to a system bus 308 and can intercouple devices included in the processor-based device 300. As is well known, the processor device 302 communicates with these other devices by exchanging address, control, and data information over the system bus 308. For example, the processor device 302 can communicate bus transaction requests to a memory controller 310. Although not illustrated in FIG. 3, multiple system buses 308 could be provided, wherein each system bus 308 constitutes a different fabric.

Other devices may be connected to the system bus 308. As illustrated in FIG. 3, these devices can include a memory system 312, one or more input devices 314, one or more output devices 316, one or more network interface devices 318, and one or more display controllers 320, as examples. The input device(s) 314 can include any type of input device, including, but not limited to, input keys, switches, voice processors, etc. The output device(s) 316 can include any type of output device, including, but not limited to, audio, video, other visual indicators, etc. The network interface device(s) 318 can be any devices configured to allow exchange of data to and from a network 322. The network 322 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 318 can be configured to support any type of communications protocol desired. The memory system 312 can include the memory controller 310 coupled to one or more memory arrays 324.

The processor device 302 may also be configured to access the display controller(s) 320 over the system bus 308 to control information sent to one or more displays 326. The display controller(s) 320 sends information to the display(s) 326 to be displayed via one or more video processors 328, which process the information to be displayed into a format suitable for the display(s) 326. The display(s) 326 can include any type of display, including, but not limited to, a cathode ray tube (CRT), a liquid crystal display (LCD), a plasma display, a light emitting diode (LED) display, etc.

The processor-based device 300 in FIG. 3 may include a set of instructions (captioned as “INST” in FIG. 3) 330 that may be executed by the processor device 302 for any application desired according to the instructions. The instructions 330 may be stored in the memory system 312, the processor device 302, and/or the cache memory 306, each of which may comprise an example of a non-transitory computer-readable medium. The instructions 330 may also reside, completely or at least partially, within the memory system 312 and/or within the processor device 302 during their execution. The instructions 330 may further be transmitted or received over the network 322, such that the network 322 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 330. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It is to be understood that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor-based device, comprising an optimization circuit configured to:
   receive a first reward vector, comprising a plurality of reward values, and a state for a current time interval;
   generate, using a reinforcement learning (RL) model, one or more actions for a next time interval based on maximizing a scalarized value of expected discounted cumulative rewards for future time intervals;
   determine whether a predicted system configuration corresponding to the one or more actions is different from a current system configuration; and
   responsive to determining that the predicted system configuration corresponding to the one or more actions is different from the current system configuration, perform the one or more actions to apply the predicted system configuration.
2. The processor-based device of clause 1, wherein the plurality of reward values comprises:
   a power reward value based on a digital power meter (DPM) value of the processor-based device;
   a performance reward value calculated based on a sum of differences between a series of current timeline margin values and corresponding target timeline margin values; and
   a thermal reward value calculated based on a sum of differences between a series of target thermal state values and corresponding current thermal state values of the processor-based device.
3. The processor-based device of clause 2, wherein the target timeline margin value and the target thermal state value are based on a current operating condition of the processor-based device.
4. The processor-based device of any one of clauses 1-3, wherein the state comprises one or more of a history of a plurality of hardware program counters (HPCs) of the processor-based device, a configuration history of the processor-based device, an action sequence history of the processor-based device, and an application metadata history of the processor-based device.
5. The processor-based device of any one of clauses 1-4, wherein the one or more actions comprises one or more of a resource management operation, a capability throttling operation, a software mitigation operation, and a clock operation.
6. The processor-based device of any one of clauses 1-5, wherein the optimization circuit is further configured to initialize the RL model based on a thermal/performance/power (TPP) reward model and a state transition model.
7. The processor-based device of any one of clauses 1-6, wherein the processor-based device is a modem device.
8. The processor-based device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
9. A processor-based device, comprising:
   means for receiving a first reward vector, comprising a plurality of reward values, and a state for a current time interval;
   means for generating, using a reinforcement learning (RL) model, one or more actions for a next time interval based on maximizing a scalarized value of expected discounted cumulative rewards for future time intervals;
   means for determining whether a predicted system configuration corresponding to the one or more actions is different from a current system configuration; and
   means for performing the one or more actions to apply the predicted system configuration, responsive to determining that the predicted system configuration corresponding to the one or more actions is different from the current system configuration.
10. A method for performing on-device reinforcement learning (RL) for optimization, comprising:
   receiving, by an optimization circuit of a processor-based device, a first reward vector, comprising a plurality of reward values, and a state for a current time interval;
   generating, by the optimization circuit using an RL model, one or more actions for a next time interval based on maximizing a scalarized value of expected discounted cumulative rewards for future time intervals;
   determining, by the optimization circuit, that a predicted system configuration corresponding to the one or more actions is different from a current system configuration; and
   responsive to determining that the predicted system configuration corresponding to the one or more actions is different from the current system configuration, performing, by the optimization circuit, the one or more actions to apply the predicted system configuration.
11. The method of clause 10, wherein the plurality of reward values comprises:
   a power reward value based on a digital power meter (DPM) value of the processor-based device;
   a performance reward value calculated based on a sum of differences between a series of current timeline margin values and corresponding target timeline margin values; and
   a thermal reward value calculated based on a sum of differences between a series of target thermal state values and corresponding current thermal state values of the processor-based device.
12. The method of clause 11, wherein the target timeline margin value and the target thermal state value are based on a current operating condition of the processor-based device.
13. The method of any one of clauses 10-12, wherein the state comprises one or more of a history of a plurality of hardware program counters (HPCs) of the processor-based device, a configuration history of the processor-based device, an action sequence history of the processor-based device, and an application metadata history of the processor-based device.
14. The method of any one of clauses 10-13, wherein the one or more actions comprises one or more of a resource management operation, a capability throttling operation, a software mitigation operation, and a clock operation.
15. The method of any one of clauses 10-14, further comprising initializing the RL model based on a thermal/performance/power (TPP) reward model and a state transition model.
16. A non-transitory computer-readable medium, having stored thereon computer-executable instructions that, when executed by a processor device of a processor-based device, cause a dependency identifier circuit of the processor device to:
   receive a first reward vector, comprising a plurality of reward values, and a state for a current time interval;
   generate, using a reinforcement learning (RL) model, one or more actions for a next time interval based on maximizing a scalarized value of expected discounted cumulative rewards for future time intervals;
   determine whether a predicted system configuration corresponding to the one or more actions is different from a current system configuration; and
   responsive to determining that the predicted system configuration corresponding to the one or more actions is different from the current system configuration, perform the one or more actions to apply the predicted system configuration.
17. The non-transitory computer-readable medium of clause 16, wherein the plurality of reward values comprises:
   a power reward value based on a digital power meter (DPM) value of the processor-based device;
   a performance reward value calculated based on a sum of differences between a series of current timeline margin values and corresponding target timeline margin values; and
   a thermal reward value calculated based on a sum of differences between a series of target thermal state values and corresponding current thermal state values of the processor-based device.
18. The non-transitory computer-readable medium of clause 17, wherein the target timeline margin value and the target thermal state value are based on a current operating condition of the processor-based device.
19. The non-transitory computer-readable medium of any one of clauses 16-18, wherein the state comprises one or more of a history of a plurality of hardware program counters (HPCs) of the processor-based device, a configuration history of the processor-based device, an action sequence history of the processor-based device, and an application metadata history of the processor-based device.
20. The non-transitory computer-readable medium of any one of clauses 16-19, wherein the one or more actions comprises one or more of a resource management operation, a capability throttling operation, a software mitigation operation, and a clock operation.

What is claimed is:

1. A processor-based device, comprising an optimization circuit configured to:
receive a first reward vector, comprising a plurality of reward values, and a state for a current time interval;
generate, using a reinforcement learning (RL) model, one or more actions for a next time interval based on maximizing a scalarized value of expected discounted cumulative rewards for future time intervals;
determine whether a predicted system configuration corresponding to the one or more actions is different from a current system configuration; and
responsive to determining that the predicted system configuration corresponding to the one or more actions is different from the current system configuration, perform the one or more actions to apply the predicted system configuration.

2. The processor-based device of claim 1, wherein the plurality of reward values comprises:
a power reward value based on a digital power meter (DPM) value of the processor-based device;
a performance reward value calculated based on a sum of differences between a series of current timeline margin values and corresponding target timeline margin values; and
a thermal reward value calculated based on a sum of differences between a series of target thermal state values and corresponding current thermal state values of the processor-based device.

3. The processor-based device of claim 2, wherein the target timeline margin value and the target thermal state value are based on a current operating condition of the processor-based device.

4. The processor-based device of claim 1, wherein the state comprises one or more of a history of a plurality of hardware program counters (HPCs) of the processor-based device, a configuration history of the processor-based device, an action sequence history of the processor-based device, and an application metadata history of the processor-based device.

5. The processor-based device of claim 1, wherein the one or more actions comprises one or more of a resource management operation, a capability throttling operation, a software mitigation operation, and a clock operation.

6. The processor-based device of claim 1, wherein the optimization circuit is further configured to initialize the RL model based on a thermal/performance/power (TPP) reward model and a state transition model.

7. The processor-based device of claim 1, wherein the processor-based device is a modem device.

8. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor-based device, comprising:
means for receiving a first reward vector, comprising a plurality of reward values, and a state for a current time interval;
means for generating, using a reinforcement learning (RL) model, one or more actions for a next time interval based on maximizing a scalarized value of expected discounted cumulative rewards for future time intervals;
means for determining whether a predicted system configuration corresponding to the one or more actions is different from a current system configuration; and
means for performing the one or more actions to apply the predicted system configuration, responsive to determining that the predicted system configuration corresponding to the one or more actions is different from the current system configuration.

10. A method for performing on-device reinforcement learning (RL) for optimization, comprising:
receiving, by an optimization circuit of a processor-based device, a first reward vector, comprising a plurality of reward values, and a state for a current time interval;
generating, by the optimization circuit using an RL model, one or more actions for a next time interval based on maximizing a scalarized value of expected discounted cumulative rewards for future time intervals;
determining, by the optimization circuit, that a predicted system configuration corresponding to the one or more actions is different from a current system configuration; and
responsive to determining that the predicted system configuration corresponding to the one or more actions is different from the current system configuration, performing, by the optimization circuit, the one or more actions to apply the predicted system configuration.

11. The method of claim 10, wherein the plurality of reward values comprises:
a power reward value based on a digital power meter (DPM) value of the processor-based device;
a performance reward value calculated based on a sum of differences between a series of current timeline margin values and corresponding target timeline margin values; and
a thermal reward value calculated based on a sum of differences between a series of target thermal state values and corresponding current thermal state values of the processor-based device.

12. The method of claim 11, wherein the target timeline margin value and the target thermal state value are based on a current operating condition of the processor-based device.

13. The method of claim 10, wherein the state comprises one or more of a history of a plurality of hardware program counters (HPCs) of the processor-based device, a configuration history of the processor-based device, an action sequence history of the processor-based device, and an application metadata history of the processor-based device.

14. The method of claim 10, wherein the one or more actions comprises one or more of a resource management operation, a capability throttling operation, a software mitigation operation, and a clock operation.

15. The method of claim 10, further comprising initializing the RL model based on a thermal/performance/power (TPP) reward model and a state transition model.

16. A non-transitory computer-readable medium, having stored thereon computer-executable instructions that, when executed by a processor device of a processor-based device, cause a dependency identifier circuit of the processor device to:
receive a first reward vector, comprising a plurality of reward values, and a state for a current time interval;
generate, using a reinforcement learning (RL) model, one or more actions for a next time interval based on maximizing a scalarized value of expected discounted cumulative rewards for future time intervals;
determine whether a predicted system configuration corresponding to the one or more actions is different from a current system configuration; and
responsive to determining that the predicted system configuration corresponding to the one or more actions is different from the current system configuration, perform the one or more actions to apply the predicted system configuration.

17. The non-transitory computer-readable medium of claim 16, wherein the plurality of reward values comprises:
a power reward value based on a digital power meter (DPM) value of the processor-based device;
a performance reward value calculated based on a sum of differences between a series of current timeline margin values and corresponding target timeline margin values; and
a thermal reward value calculated based on a sum of differences between a series of target thermal state values and corresponding current thermal state values of the processor-based device.

18. The non-transitory computer-readable medium of claim 17, wherein the target timeline margin value and the target thermal state value are based on a current operating condition of the processor-based device.

19. The non-transitory computer-readable medium of claim 16, wherein the state comprises one or more of a history of a plurality of hardware program counters (HPCs) of the processor-based device, a configuration history of the processor-based device, an action sequence history of the processor-based device, and an application metadata history of the processor-based device.

20. The non-transitory computer-readable medium of claim 16, wherein the one or more actions comprises one or more of a resource management operation, a capability throttling operation, a software mitigation operation, and a clock operation.
